(19) United States
(12) Patent Application Publication
(10) Pub. No.: US 2006/0149425 A1
(43) Pub. Date: Jul. 6, 2006

(54) Motion sensor system

(76) Inventor: Raymond Allen Davis, Salem, OR (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/021,035

(22) Filed: Dec. 22, 2004

(51) Int. Cl. G06F 17/00

(52) U.S. Cl. 701/1

(57) ABSTRACT

A vehicle includes a motion sensor and a control processor. The motion sensor optically detects motion of the vehicle with respect to an underlying surface. The motion sensor includes a variable focus imager. The control processor receives information from the motion sensor and calculates location of the vehicle, speed of the vehicle and/or acceleration of the vehicle.

### BACKGROUND

Wheel rotation has been used to approximate speed and distance traveled by an automobile. This information is communicated to a driver, for example, via a speedometer and odometer. When more precise information is needed, for example for new vehicle performance and evaluation, a “fifth” wheel can be attached to a vehicle to more precisely record speed and distance. When using systems based on measurement of wheel rotation, tracking errors can be introduced, for example, by a wheel slipping or skidding.

Systems based on measurement of wheel rotation can also be used for navigation purposes such as determining an absolute position of a vehicle, or a relative position of the vehicle with respect to one or more locations. Navigation systems for automobiles are used to allow drivers to track current location and plot out routes. However, again, skidding, slipping, braking, etc. can introduce inaccuracies into such systems based on measurement of wheel rotation.

Many of the disadvantages of systems based on measurement of wheel rotation are overcome by using global positioning systems (GPS). Global positioning systems operate by receiving signals from global positioning system satellites to obtain information such as position and velocity.

GPS systems have been combined with detailed electronic maps to aid in the navigation of automobiles. For example, GPS-based navigation tools typically contain a reference base map showing Interstate, U.S., and State highways, plus rivers and lakes in large regions, such as the U.S., Canada, and Mexico. Additional detail may be shown such as main arterial streets in metropolitan areas, detailed street-level map information and even access to business listings and points of interest in a particular area. For example, upon entry of a street address or points of interest (such as restaurants, hotels, gas stations, banks, and shopping areas), some navigation tools will display the location on a map along with current vehicle location. Nevertheless, most GPS systems have accuracy limited to within a few feet and are susceptible to obstacles, multi-path reflections and hostile jamming. This significantly limits the use of most GPS systems for determination of speed and measurement of exact distances.

### SUMMARY OF THE INVENTION

In accordance with an embodiment of the present invention, a vehicle includes a motion sensor and a control processor. The motion sensor optically detects motion of the vehicle with respect to an underlying surface. The motion sensor includes a variable focus imager. The control processor receives information from the motion sensor and calculates location of the vehicle, speed of the vehicle and/or acceleration of the vehicle.

### BRIEF DESCRIPTION OF THE DRAWINGS

FIG. 1 is a simplified not-to-scale underside view of a vehicle in accordance with an embodiment of the present invention.

FIG. 2 is a simplified view of an optical motion sensor mounted on the underside of a vehicle in accordance with an embodiment of the present invention.

FIG. 3 is a simplified block diagram of optical motion sensor circuitry used for location and motion detection in accordance with an embodiment of the present invention.

FIG. 4 is a simplified flowchart illustrating operation of processor control for an optical motion sensor in accordance with an embodiment of the present invention.

FIG. 5 is a simplified diagram illustrating a tracking vehicle using an optical sensor to monitor tracked vehicles in accordance with an embodiment of the present invention.

### DESCRIPTION OF THE EMBODIMENT

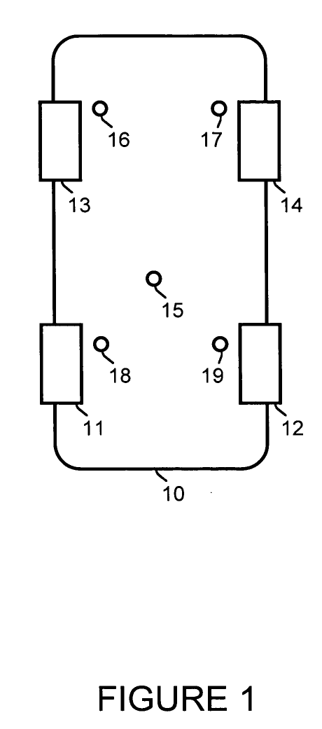

FIG. 1 is a simplified not-to-scale underside view of a vehicle 10. For example, vehicle 10 is an automobile, motorcycle, truck, recreation vehicle, snowmobile or some other vehicle that travels on a surface. A wheel 11, a wheel 12, a wheel 13 and a wheel 14 of vehicle 10 are used to roll vehicle 10 across an underlying surface. Wheels 11 through 14 are illustrative as the present invention is useful not only for four-wheel vehicles, but also for motorcycles, snowmobiles and other types of vehicle. An orifice 15 is the location of an optical sensor. Additional optical sensors may be mounted at other locations. For example, FIG. 1 shows an orifice 16, an orifice 17, an orifice 18 and an orifice 19 mounted on the underside of vehicle 10. Orifice 16, orifice 17, orifice 18 and orifice 19 represent additional optional optical sensors that can be used to serve as redundant optical sensors for back-up sensing, and/or for tracking speed or acceleration of different locations of vehicle 10. Alternatively, or in combination, orifice 16, orifice 17, orifice 18, and/or orifice 19 represent the location of additional optional illuminators for the optical sensor located at orifice 15. For example, illuminators at orifice 16, orifice 17, orifice 18, and/or orifice 19 can be used to optimize the “grazing” angle of the illumination to highlight surface details in the captured images.

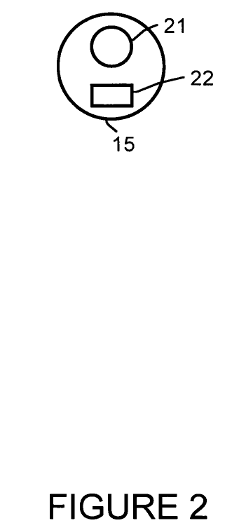

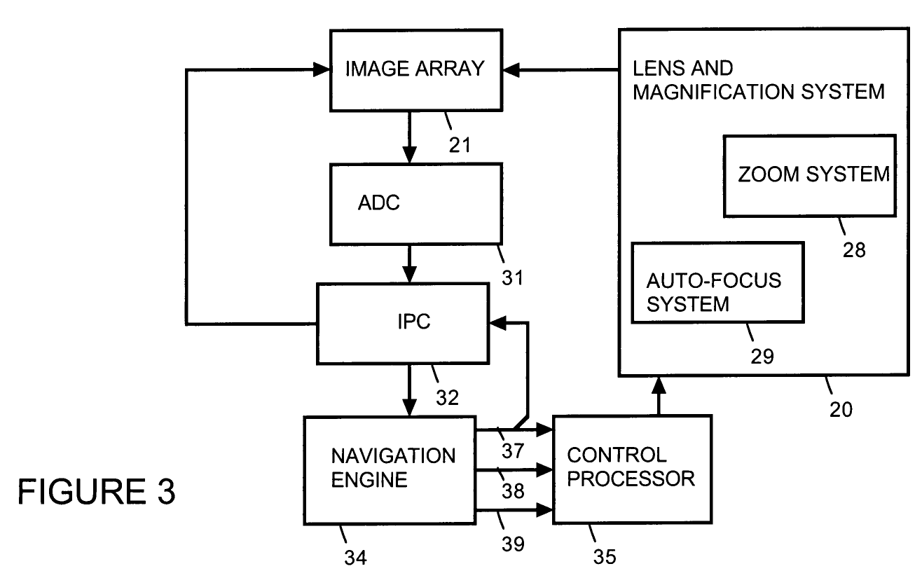

FIG. 2 shows an illuminator 22 and an image array 21 within orifice 15. For example, various optics and optical filters, as necessary or desirable, are included within illuminator 22 and/or image array 21. For example, a lens and magnification system 20 (shown in FIG. 3) with a narrow depth-of-field is used to deliver images to image array 21. Lens and magnification system 20 includes an auto-focus system 29 and zoom system 28. Lens and magnification system 20 precisely focuses and blurs surface features in the field of view (FOV) of image array 21. For example, illuminator 22 and image array 21 respectively generate and process color light. The colors produced by illuminator 22 enhance surface features in the FOV that are detected by image array 22. Additionally, for example, illuminator 22 can operate outside of the human-visible color spectrum, for example in the infrared spectrum. Alternatively, for example, image array 22 can be a black-and-white (non-color) imager that is used alone or in combination with a color imager.

A short depth of field increases the blur between objects at different distances. Auto-focus system 29 and zoom system 28 allow the optical motion sensor circuitry to measure range in the FOV of image array 21. With ranging capability added to highly accurate x and y positioning, the optical motion sensor circuitry can correlate absolute position accurately over short distances. Zoom system 28 makes the optical motion sensor circuitry more extensible and adaptable to various heights above a surface, so that ranging can be optimized for a height of a given vehicle or aerial flyer. This is desirable as it works with a controlled amount of blur, which prevents aliasing and aids in the interpolation of motion detection in the navigation sensor. Other methods to determine range in FOV for purpose of determining absolute displacements can be implemented alternatively or in addition to the use of zoom system 28. For more information on auto-focusing to determine distance, see for example, Subbarao in “Depth from Defocus: A Spatial Domain Approach”, Intl. J. of Computer Vision, 13:271-294, 1994 and Gordon et al in “Silicon Optical Navigation” which may be accessed on the internet at http://www.labs.agilent.com/news/2003features/news_fast50_gordon.html.

For example, illuminator 22 is implemented using a light emitting diode (LED), an infrared (IR) LED, a high powered laser diode or other lighting device. For example, illuminator 22 is a high-speed strobe or flash. In situations where ambient light is sufficient for image array to detect navigable features of an underlying surface without additional illumination, illuminator 22 can be temporarily shut down or even omitted if not necessary.

FIG. 3 is a simplified block diagram of an optical motion sensing system. Image array 21 is implemented, for example, using a 32 by 32 array of photodetectors. Alternatively, image array 21 can be implemented using other technology and/or other array sizes can be used. For example, the size and optical features of image array 21 are optimized to resolve surface features, so that motion can be detected and measured.

An analog-to-digital converter (ADC) 31 receives analog signals from image array 21 and converts the signals to digital data. The digital data represents “raw” or unprocessed sensor information. The analog pixel voltages can be converted into 6, 8, 10, or other-bit digital values, as necessary for resolution or for downstream processing efficiency, as needed.

An image processor control (IPC) 32 processes digital data received from ADC 31 and performs, for example, auto-exposure (AE) by determining optimal exposure time and pixel gain adjust within image array 21. This is done, for example, to prevent saturation or underexposure of images captured by image array 21. Additional functionality such as anti-vignetting or other lens correction, pixel correction, sizing, windowing, sharpening, processed image data formatting and outputting and other image processing can be performed within IPC 32.

Exposure time can be controlled using, for example, an electronic (e.g., “rolling” reset) shutter or a mechanical shutter used with or without strobe flash illumination. The optimal device used for exposure time control can vary dependent on the required accuracy for motion detection and desired overall system cost for a particular application. The illumination system can assist in the shortening of pixel exposure time to enable or maintain high frame rates as necessary to capture features moving in the FOV.

Other image processing algorithms can be invoked to, for example, identify and optimize for the texture of the roadway surface (e.g. asphalt, gravel, wet, dry, icy, etc.), and to apply sharpening or other feature enhancement techniques to optimize image detection and hence motion measurement. For example, detection of ice on the surface can result in a signal and/or warning to a vehicle driver. In applications for a motion detector, such as for a pedometer, an algorithm is used to remove the obstacles of the pedestrian's feet in the field of view of image array 21 before correlation is performed.

A navigation engine 34 evaluates the digital data from IPC 32 and performs a series of correlations to estimate the direction and magnitude of motion most likely to account for the difference between images taken at different times. Navigation engine 34 then determines a delta x (ΔX) value to be placed on an output 38 and determines a delta y (ΔY) value to be placed on an output 39. For example, ΔY represents movement in the forward or reverse direction of the vehicle and ΔX represents sideways motion of the vehicle. ΔX and ΔY can be either positive or negative. A positive ΔY indicates forward motion, a negative ΔY indicates motion in a reverse direction, a positive ΔX indicates motion toward one side, and a negative ΔX indicates motion towards another side.

ΔX and ΔY represent are correlated to represent actual displacement or distance. For example, optical zoom and auto-focus algorithms are used to focus features in the FOV, and from those settings determine the precise distance to (and hence between) the tracked motion, resulting in correlations to actual displacements. Alternatively, or in addition, other means of distance detection can be used, including sonar, radar, or light detecting and ranging (LIDAR), to measure position of the imager above the surface (see for example, U.S. Pat. No. 5,644,139, by Allen et al. for Navigation Technique for Detecting Movement of Navigation Sensors Relative to an Object). The frame rate at which image array 21 captures images is known. Therefore, it is possible from the available information to calculate time dependent characteristics such as speed (velocity) and acceleration. For applications that require detection of motion in the vertical (Z) direction, it is also possible to determine Z displacement. See, for example, U.S. Pat. No. 6,433,780 by Gordon, et al., for Seeing Eye Mouse for a Computer System.

Tracking angular rotation allows the navigation system to autonomously determine vehicle heading. This is can be accomplished using multiple optical sensors. Placing two or more optical sensors on a vehicle allows accurate reporting on skidding, slipping and other vehicle behavior, while maintaining accurate heading and odometry necessary for autonomous navigation over short distances.

Navigation engine 34 also generates a quality signal 37 that indicates the quality of the image detected by image array 21. For example, quality signal 37 represents an estimation of the likelihood that the ΔX and ΔY values represent the true motion of the vehicle with respect to an underlying surface. For example, this likelihood is based on the number of navigable features detected by image array 21. Alternatively, other methodology may be used to determine the quality of the image detected by image array 21. See, for example, ways quality is determined in U.S. Pat. No. 6,433,780. Quality signal 37 is fed back to IPC 32 to, for example, assist in the convergence of the algorithms to optimize illumination or frame rate. Quality signal 37 also is fed forward into control processor 35 and used, for example, as part of an error detection and correction scheme to improve system robustness or redundancy.

Typically, when quality signal 37 indicates the likelihood that the ΔX and ΔY values do not represent the true motion of the vehicle with respect to an underlying surface, this indicates for example, that dirt or grime is obstructing image array 21 or illuminator 22.

Quality signal 37 is, for example, a binary signal indicating whether quality is acceptable or not acceptable. Alternatively, quality signal 37 is a numeric value indicating level of quality. For example, the numeric value is related to how well reference and sample frames are correlated in the motion detection process. The numeric value is compared to, for example, a minimum accept value or threshold, for acceptance or rejection. A Kalman filter or other type of filter can be used to blend previous measurements and reduce the error variance in the presence of missing (or poorer quality) measurements.

A control processor 35 receives ΔX on output 38 and ΔY on output 39. Based on the current and past values of ΔX and ΔY, control processor 35 is able to determine location, speed and acceleration of vehicle 10. Control processor 35 also updates an odometer reading indicating total distance traveled by the vehicle. In an alternative embodiment of the present invention, output 38 and output 39 are replaced with a first-in-first-out (FIFO) memory. Navigation engine 34 buffers values for ΔX and ΔY, along with frame rate information, if necessary, in the FIFO memory. Control processor 35 accesses the FIFO memory for the buffered values.

For example, control processor 35 is implemented as a stand-alone processor. Alternatively, control processor 35 is integrated with IPC 32, ADC 31 and navigation 34 as a system-on-chip (SOC) device. Image array 21 and associated optics can also be integrated as a single component module that can optionally include illuminator 22. A flexible printed circuit board (PCB) or other substrate can be used that provides for, for example, low-cost and high-reliable assembly, installation, and operation. Interfaces between blocks can be accomplished using serial, parallel, wireless, optical and/or some other communication means.

Control processor 35 controls lens and magnification system 20. As shown in FIG. 3, lens and magnification system 20 includes zoom system 28 and auto-focus system 29. Since lens and magnification system 20 includes zoom system 28 and auto-focus system 29, image array 21 and lens and magnification system 20 can be collectively referred to as a variable focus imager.

Using a variable focus imager has significant advantages over use of a “fixed” focus system. A variable focus imager allows resolution of sufficient detail for surface correlation to work even when the distance between the optical motion sensor and an underlying surface is not constant.

When image array 21, illuminator 22, control processor 35, IPC 32, ADC 31 and navigation 34 are all integrated together as a single module, the resulting module sensor can be used for alternate applications. For example, such a motion sensor can be used as a pedometer placed on a person's belt or integrated in the sole of a shoe or sandal. This allows tracking not only of distance traveled, but can also be used to track speed and acceleration.

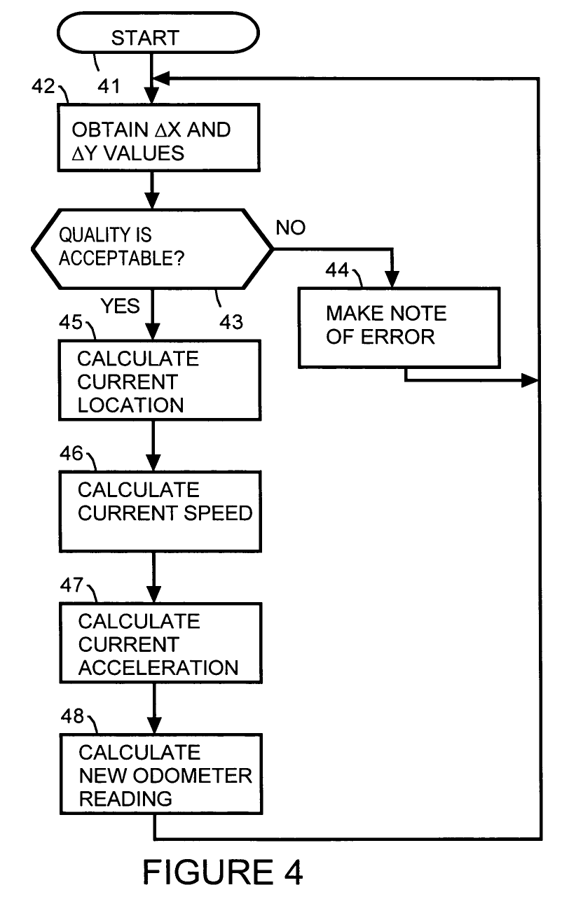

For example, FIG. 4 is a simplified flowchart illustrating operation of control processor 35 when calculating location speed and acceleration of vehicle 10. In a block 40, vehicle motion brings the system out of a low-power state and activates the system. Alternatively, the vehicle is turned on or some other event triggers start of the output signal generation process. The system returns to a low-power state as necessary or desired, such as when no motion is detected.

In a block 41, control processor 35 obtains a ΔX value and a ΔY value. For example, navigation engine 34 is able to generate hundreds of ΔX values and ΔY values per second. In some applications, dependent upon desired accuracy and available resources, it may be sufficient to sum the ΔX values and the ΔY values received by control processor 35 over a predetermined amount of time. The predetermined amount of time is, for example, optimized for the particular application and desired accuracy.

In a block 42, a check is made to see if quality signal 37 is at an acceptable level. If in block 42, quality signal 37 is not acceptable, this indicates, for example, some malfunction such as dirt or grime on the image array or illuminator. In a block 44, a note is made of the error and the appropriate message is indicated to the vehicle driver. The message could be, for example, in the form of a light signaling a diagnostic error or a warning sound, and so on. Also, readings from a back-up optical sensor, if available, may be used instead of readings from the optical sensor providing inadequate quality. Alternatively, or in addition, a corrective action can be initiated. For example, an automated system can be used to clean image array 21, and/or illuminator 22. For example, a sheet of transparent film is advanced across the lens of image array 21 removing any obstruction, such as road spray.

If, in block 43, quality signal 37 is at an acceptable level, in a block 45 current location of vehicle 10 is calculated. This is done, for example by adding the current ΔX value and the ΔY value to a previous location to obtain a current location.

In a block 46 current speed of vehicle 10 is calculated. This is done, for example by calculating distance traveled by vehicle, calculated for example by dividing the square root of the sum of the current ΔX value squared and the current ΔY value squared by elapsed time.

In a block 47 current acceleration of vehicle 10 is calculated. This is done, for example by subtracting the previous speed of vehicle from the current speed of vehicle, then dividing the result by elapsed time.

In a block 48 a new odometer reading for vehicle 10 is calculated. This is done, for example by calculating distance traveled by vehicle and adding the calculated distance to the previous odometer reading. Distance can be calculated, for example, by dividing the square root of the sum of the current ΔX value squared and the current ΔY value squared. Other less accurate ways to calculate distance travel can also be used. For example, distance can be estimated using the current ΔY value.

In addition to position-based navigation, it is possible to obtain position by integrating velocity over time. Thus, the change in motion or position can be determined by various numeric methods such as the rectangular rule, trapezoidal rule, or Simpson's rule, or other methods.

The motion sensor described herein can be used to implement, for example, odometer, speedometers and navigation systems. When used as a navigation system, calibration is essential to determine an original location from which other locations are determined. The motion sensor described herein can also be used instead of a tracking wheel for vehicle performance and evaluation. When integrated with other sensors and/or input sources, performance measures such as braking efficiency, yaw, tire slip, fuel efficiency and so on can be calculated. GPS systems can be combined with the motion sensor described herein to provide an optimized navigation system.

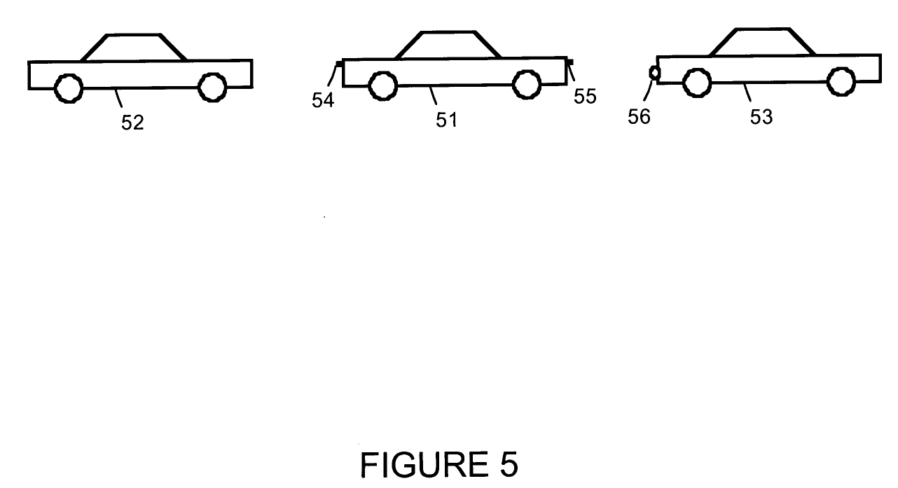

Image array 31 can also be used for other applications in addition to motion sensing. For example, image 31 could be implemented as a color image array and used to monitor driving conditions such as vehicle positioning with respect to the roadway. For example, detection of two yellow stripes in the field of vision of image 31 could indicate the vehicle has crossed a “no-passing zone”. Similarly, a white “fog” line can be detected. Appropriate alerts can be passed to the driver in such cases. Additionally, vehicle performance and driver evaluation can be monitored and appropriate alerts could be generated. Alternatively, or in addition, the motion sensor can be used within a security system. For example, if the vehicle is detected outside a predefined geographic region, a security action can be implemented. For example, the security action includes disconnecting a fuel line, notifying police and so on. The security action, for example, is overridden by entry of a predefined password. FIG. 5 shows an optical sensor 54 and an optical sensor 55 used as tracking sensors on a tracking vehicle 51 allowing, for example, tracking vehicle 51 to match speed and maintain a relative position with respect to one or more tracked vehicles, as represented by a tracked vehicle 52 and a tracked vehicle 53. Optical sensors 54 and 55 are used, for example to track relative location of tracked vehicles 52 and 53. The information provided is used to control speed, acceleration and direction of tracking vehicle 51. Optical sensor 55 is also used to detect brake lights 56 of tracked vehicle 53, allowing tracking vehicle 51 to, for example, anticipate deceleration of tracked vehicle 53.

When a tracking vehicle is, for example, an aircraft flying (autonomously) in formation with other aircraft, optical sensors can be placed strategically on the tracking vehicle to allow sensing in all directions around the aircraft. When the tracking vehicle is an underwater sea craft, optical sensors can be located, for example to allow the tracking vehicle to track the seafloor to, for example, maintain a stationary position in the presence of current.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A vehicle, comprising:
a motion sensor that optically detects motion of the vehicle with respect to an underlying surface, the motion sensor including a variable focus imager; and,
a control processor that receives information from the motion sensor and calculates at least one of the following:
location of the vehicle,
speed of the vehicle,
acceleration of the vehicle.

2. A vehicle as in claim 1 wherein the variable focus imager includes:
an image array; and,
a lens and magnification system with a zoom system.

3. A vehicle as in claim 1 wherein the motion sensor additionally includes:
an illuminator, the illuminator being a high-output laser diode.

4. A vehicle as in claim 1 additionally comprising:
a second motion sensor that optically detects motion of the vehicle with respect to the underlying surface.

5. A vehicle as in claim 1 wherein the motion sensor sends the following signals to the control processor:
a first value that indicates motion in the forward and reverse motion of the vehicle; and,
a second value that indicates sideways motion of the vehicle.

6. A vehicle as in claim 1 wherein the motion sensor sends the following signal to the control processor:
a first value that indicates motion in the forward and reverse motion of the vehicle;
a second value that indicates sideways motion of the vehicle; and,
a third value that indicates quality of a detected image of the underlying surface.

7. A motion detection system, comprising:
means for optically detecting motion with respect to an underlying surface; and,
means for calculating at least one of the following from the optically detected motion:
speed with respect to the underlying surface;
acceleration with respect to the underlying surface.

8. A motion detection system as in claim 7 wherein the means for optically detecting motion includes:
a variable focus imager.

9. A motion detection system as in claim 7, wherein the motion detection system provides image information for at least one of the following:
driving conditions;
geographic information for vehicle security purposes.

10. A motion detection system as in claim 7 additionally comprising means for calculating at least one of the following:
location with respect to an original location;
total distance traveled with respect to a starting point.

11. A motion detection system as in claim 10, wherein the motion detection system is within one of the following:
a pedometer;
an odometer system.

12. A method comprising:
optically detecting motion of a vehicle with respect to an underlying surface; and,
calculating at least one of the following from the optically detected motion:
speed of the vehicle;
acceleration of the vehicle.

13. A method as in claim 12 wherein optically detecting motion of the vehicle includes:
illuminating the underlying surface; and,
capturing an image of the underlying surface.

14. A method as in claim 12 wherein optically detecting motion of a vehicle with respect to an underlying surface comprises using two separate motion detectors to optically detect motion of the vehicle with respect to the underlying surface.

15. A method as in claim 12 wherein optically detecting motion of the vehicle includes the following:
generating a first value that indicates motion in the forward and reverse motion of the vehicle; and,
generating second value that indicates sideways motion of the vehicle.

16. A method as in claim 12 wherein optically detecting motion of the vehicle includes the following:
generating a first value that indicates motion in the forward and reverse motion of the vehicle;
generating second value that indicates sideways motion of the vehicle; and,
generating a third value that indicates quality of a detected image of the underlying surface.

17. A tracking vehicle, comprising:
a motion sensor that optically detects motion of the tracking vehicle with respect to a tracked vehicle; and,
a control processor that receives information from the motion sensor and calculates relative position of the tracked vehicle with respect to the tracking vehicle.

18. A tracking vehicle as in claim 17, wherein the tracking vehicle uses the relative position of the tracked vehicle to match at least one of the following:
speed of the tracking vehicle to speed of the tracked vehicle;
direction of travel of the tracking vehicle to direction of travel of the tracked vehicle;
acceleration of the tracking vehicle to acceleration of the tracked vehicle.

19. A tracking vehicle as in claim 17, wherein the tracking vehicle uses the relative position of the tracked vehicle to maintain approximately constant the relative position of the tracked vehicle to the tracking vehicle.

20. A tracking vehicle as in claim 17 wherein the tracking vehicle additionally monitors brake lights of the tracking vehicle.
